(19) United States
(12) Patent Application Publication
(10) Pub. No.: US 2006/0153608 A1
(43) Pub. Date: Jul. 13, 2006

(54) System and method for determining printing media is appropriate for use in a printer/copier

(75) Inventors: Paul C. Lucas, Sherwood, OR (US); H. Erwin Grellmann, Beaverton, OR (US); Albert B. Levit, Wilsonville, OR (US)

Correspondence Address: Patrick D. Floyd;FAY, SHARPE, FAGAN, MINNICH & McKEE, LLP, SEVENTH FLOOR, 1100 SUPERIOR AVENUE, CLEVELAND, OH, 44114-2579, US

(73) Assignee: Xerox Corporation

(21) Appl. No.: 11/033,094

(22) Filed: Jan. 10, 2005

(51) Int. Cl. G03G 15/00

(52) U.S. Cl. 399/389

(57) ABSTRACT

A method of printer/copier obtaining information from printer/copier printing media is provided. The method includes placing the printing media in the printer/copier, the printer/copier sensing for identifying markings on the printing media identifying the printing media as the appropriate printing media for the printer/copier, the printer/copier determining if the printing media is the appropriate printing media for use in the printer/copier. A printer/copier system for obtaining information from printing media for use in a printer/copier is provided. The printer/copier system includes a sensor for sensing for identifying markings on the printing media identifying the printing media as the appropriate printing media for the printer/copier, and a controller for determining if the printing media is the appropriate printing media for the printer/copier.

### BACKGROUND

Illustrated herein are embodiments relating to a method and apparatus for obtaining information from printer/copier printing media and determining if the printing media is appropriate for use with a printer/copier. It finds particular application in conjunction with an imaging apparatus, and will be described with particular reference thereto. However, it is to be appreciated that the present exemplary embodiment is also amenable to other like applications.

Many printers/copiers are capable of forming an image on uncoated and coated papers. However, many machines require that the physical properties of such papers, such as coating properties and the like, are correctly matched to the printer to provide good results. For example, in the case of laser printers, the change from oiled to oil-less fusers has created compatibility problems with certain coated paper. When coated paper, such as digital color photo glossy paper, designed for laser printers equipped with oiled fusers is used in printers having oil-less fuser, the paper can stick to the fuser and perhaps even cause damage. Similar problems can arise with the use of transparencies having physical properties which are incompatible with image forming machines such as printers and copiers and the like.

Sometimes people can knowingly substitute the wrong printing media not realizing it can damage a printer/copier. In other cases, printing media products can be incorrectly promoted as being safe for use in a broad class of printer/copiers, such as safe for use in color laser printers, when these products should be promoted for use in a more narrow class of machines, such as color laser printers having oiled fusers. Problems are more likely to arise when a customer uses printing media made by a manufacturer that did not make or sell the printer/copier device. Further, it is not readily apparent on the face of the printing media which products are compatible with a particular printer/copier, since this information will usually interfere with the intended use of the printed product, and the wrong products can unknowingly be used. As a result, it is desirable for the printer/copier to be able to determine that a printing media is appropriate for use in that machine.

### BRIEF DESCRIPTION

A system and method for obtaining information from printer/copier printing media and determining that the printing media is appropriate for use in the printer/copier is provided.

In accordance with a first aspect of the invention, the method includes placing the printing media in the printer/copier, the printer/copier sensing for identifying markings on the printing media identifying the printing media as the appropriate printing media for the printer/copier, and the printer/copier determining if the printing media is the appropriate printing media for use in the printer/copier.

In accordance with a second aspect of the invention, the system includes a sensor for sensing for identifying markings on the printing media identifying the printing media as the appropriate printing media for the printer/copier, and a controller for determining if the printing media is the appropriate printing media for the printer/copier.

Further scope of the applicability of the embodiments provided herein will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

FIG. 1 is a block diagram of a system for obtaining information from printer/copier printing media;

FIG. 2 is a block diagram of another example of a system for obtaining information from printer/copier printing media;

FIG. 3 is flow chart illustrating a method of obtaining information from printer/copier printing media;

FIG. 4 is a flow chart illustrating a method of sensing for identifying markings on printing media;

FIG. 5 is a flow chart illustrating a method of determining if printing media is appropriate for use in a printer/copier;

FIG. 6 is a block diagram illustrating a printing media having identifying markings;

FIG. 7 is a block diagram illustrating a printing media having identifying markings;

FIG. 8 is a block diagram illustrating a printing media having identifying markings;

FIG. 9 is a block diagram illustrating a printing media having identifying markings;

FIG. 10 is a block diagram illustrating a printing media having identifying markings; and

FIG. 11 is a block diagram illustrating a printing media having identifying markings.

### DETAILED DESCRIPTION

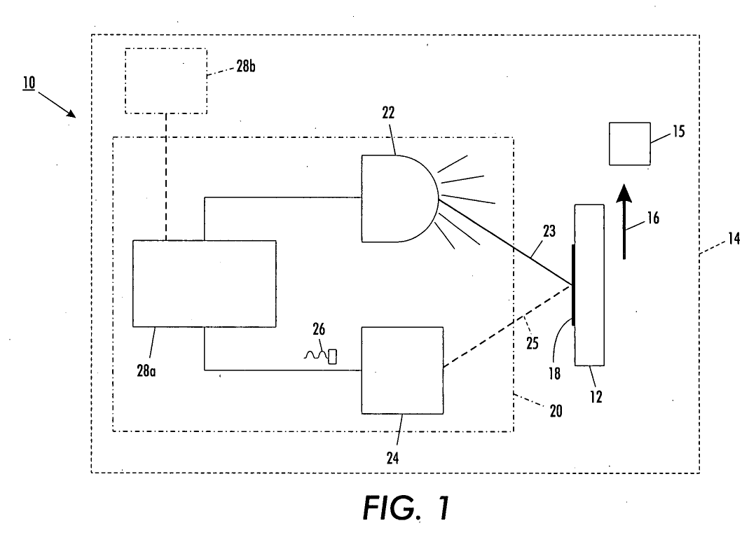

With reference to FIG. 1, a block diagram is provided illustrating a system, shown generally at 10, for a printer/copier 14 to obtain information from printing media 12 and using the obtained information in determining if the printing media is appropriate for use in the printer/copier. The printing media 12 can be said to be appropriate for the printer/copier 14 if the physical properties of the printing media are correctly matched to the printer/copier to provide optimal printing results, and/or to reduce or eliminate problems or damage to the printer/copier, including but not limited to damage to the printer/copier fuser 15. Examples of physical properties of the printing media 12 which can be matched to the printer/copier 14 can include, but are not limited to, coating characteristics, such as coating softening point, coating melt viscosity and surface free-energy. If not properly matched to the printer/copier fuser 15, these properties can combine to give a coating that will soften, flow onto the fuser and stick. It is also possible for coatings containing pigments, fillers or beads that protrude up above the surface of the sheet to be forced into the surface of the fuser roll cover, causing the sheet to stick in the surface of a polymer-coated fuser. Similarly, for Solid Ink technology, paper absorbency should be matched to the printer/copier, since highly absorbent papers, such as those used in certain aqueous ink jet applications, can absorb excessive amounts of drum oil reducing the transport reliability in the device.

The printing media 12 can be any suitable media capable of being printed on, and/or capable of having an image generated thereon, by a printer/copier 14 as it travels along a path 16 therein. The path 16 can also be referred to as a paper path 16, even though the printing media 12 may not be paper. The printing media 12 can be a generally opaque media such as paper, etc., or it can be a transparency, among others. The printer/copier 14 can be a printer, examples of which can include, but are not limited to, a solid ink printer, an ink jet printer such as a thermal ink jet printer and the like, a laser printer, a piezoelectric printer, or any other known printer, including but not limited to image forming devices driven by signals from scanners, xerographic machines or other image processing devices. The printer/copier 14 can be a copier including but not limited to an electrophotographic imaging system, also known as a xerographic system, such as that described in U.S. Pat. No. 5,146,087 to VanDusen, the disclosure of which is totally incorporated herein by reference. The printer/copier 14 can be a multifunction device which can provide printing and/or copying functions.

The printing media 12 can include one or more identifying markings 18 for providing information indicating that the printing media is the appropriate printing media for the printer/copier 14. The markings 18 can be made with a detectable material that absorbs or reflects radiation, including but not limited to light, at ultraviolet (UV) wavelengths, infrared (IR) wavelengths, or near-infrared (near-IR) wavelengths thereby reflecting radiation with characteristics specific to the markings as will be described in further detail below. Alternatively, the identifying markings 18 can be a phosphorescent material capable of fluorescing when radiation, such as ultraviolet light, infrared light, or near infrared light, is applied thereto, thereby emitting light with characteristics specific to the markings as will be described in further detail below.

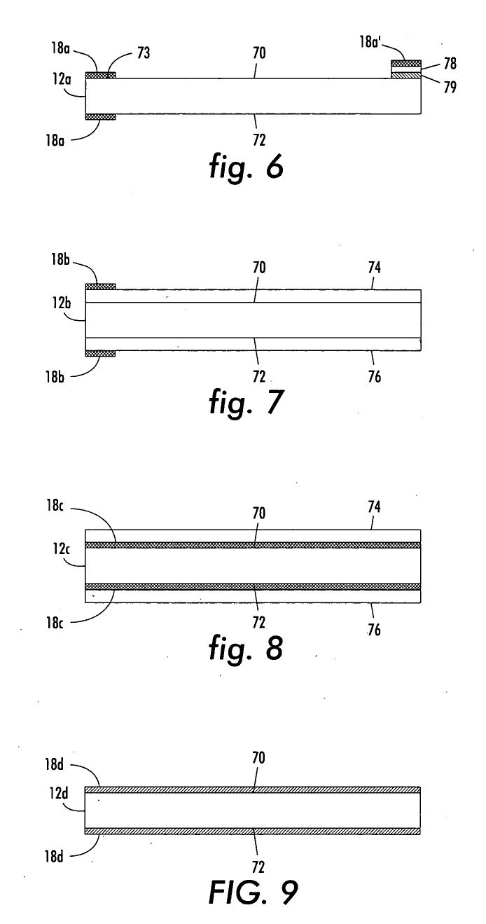

The identifying markings 18 can be not readily perceived by the unaided human eye in white light so that they will not interfere with the use of the printing media 12 after it is printed on, or they can be visible to the unaided human eye in white light. The markings 18 can preferably be applied along one or more edges (see 73 in FIG. 6) of the media. The markings 18 can be applied to the printed side and/or the back side of the printing media as will be described in further detail below.

The identifying markings 18 can be not visible to the unaided human eye in white light so as not to interfere with print markings applied by the printer/copier 14. Typical opaque printing media, such as paper, is essentially white and generally uniformly reflective at wavelengths from about 400 nm to about 800 nm. Typical transparency films are essentially transparent at wavelengths from about 280 nm to about 1200 nm. Suitable detectable materials used for the identifying markings 18 which are not easily visible can absorb radiation outside the visible region in this range. Thus, suitable detectable materials can include such things as common UV absorbers, such as hydroxybenzophenones, hydroxyphenl benzotriazoles, among other, polymers that absorb in the UV, such as polystyrene-co-vinyl anthracene, polymeric UV absorbers, among others, and near-IR absorbing dyes, such as indolium or benzopyrylium salts, or polymers containing such functionalities.

Radiation absorbing materials, such as UV absorbers, IR absorbers, or near-IR absorbers will absorb light that would normally be reflected back to the detector 24. Therefore the light reflected 25 from the identifying markings 18 reaching the detector 24 will have a reduced intensity, appearing darker, and the detector will indicate this characteristic via the output signals 26 it sends to the controller 28.

The identifying markings 18a can also include radiation-emitting materials which emit radiation having predefined characteristics as described in further detail below. The printer/copier 14 can use these characteristics to identify the printing media 12 as being appropriate for use in the printer/copier.

The printer/copier 14 can also include a sensor 20 for sensing for the identifying markings 18 on the printing media 12 as it travels along a path 16 in the printer/copier. The sensor 20 can be mounted within the printer/copier 14. Many sensor configurations can be applicable, including light sensors mounted on the image side of the sheet in the path 16, light sensors mounted on the backside of the path, combinations of reflective light sensors mounted on either side of the path, or combinations of reflected light sensors with transmitted light sensors, also referred to as emitted light sensors.

The sensor 20 includes an emitter 22 for emitting radiation which can be directed at the printing media 12. The emitter 22 can emit radiation at any suitable wavelength, including but not limited to UV light, IR light, and near-IR light. The emitter 22 is located near the paper path 16 so that the emitted radiation 23 is directed at the printing media 12 such that if the printing media contains the identifying markings 18, the emitted radiation 22 is directed at the identifying markings. The paper path 16 can be darkened to reduce the influence of ambient light.

The sensor 20 can also include a detector 24 for detecting radiation. The detected radiation 25 can be reflected radiation or emitted radiation as shall be described in further detail below. The sensor 20 produces an output signal 26, such as for example a signal produced by the detector 24 or sensor processing circuitry representative of the detected radiation 25. Examples of the output signal 26 can include, but are not limited to, an electrical waveform, a voltage, a change in resistance or impedance, among others. The detector 24 can be a photo detector for detecting light, or any other suitable known detector for detecting radiation at a predetermined wavelength or wavelengths. The detector 24 can be chosen and/or configured to detect the wavelength or wavelengths of the radiation 25 that is expected to be reflected from, or emitted by, the identifying markings 18.

The output signal 26 produced by the detector 22 upon detecting the radiation is provided to a controller 28a. The controller 28a can determine the characteristics of the detected radiation detected by the detector 24 from the output signal 26. These characteristics can include, but are not limited to, the wavelength and/or intensity of the radiation 25 reflected by the identifying markings 18, or the wavelength and/or intensity and/or decay rate of the radiation 25 emitted by the identifying markings. The controller 28a can also determine if the detected radiation characteristics indicate the printing media 12 has the identifying markings 18 identifying the printing media as appropriate printing media for use in the printer/copier 14 as shall be described in further detail below.

The system 10 can include a controller 28b for taking action taken if it is determined that the printing media 12 is not appropriate for the printer/copier 14. The controller 28b can be the same controller as controller 28a, or a different controller located apart therefrom. The action taken can include notifying the operator of the printer/copier 14 with a warning that the media 12 currently loaded in the printer/copier is not recommended for use in this printer/copier. The warning can indicate potential problems that could result from using the inappropriate printing media 12, such as failure of the fuser, improper absorption of the ink, or poor image quality in general. The controller 28 can also prevent the use of the inappropriate printing media in the printer/copier in any suitable manner, such as for example, placing the printer/copier in a standby mode until the inappropriate printing media is removed.

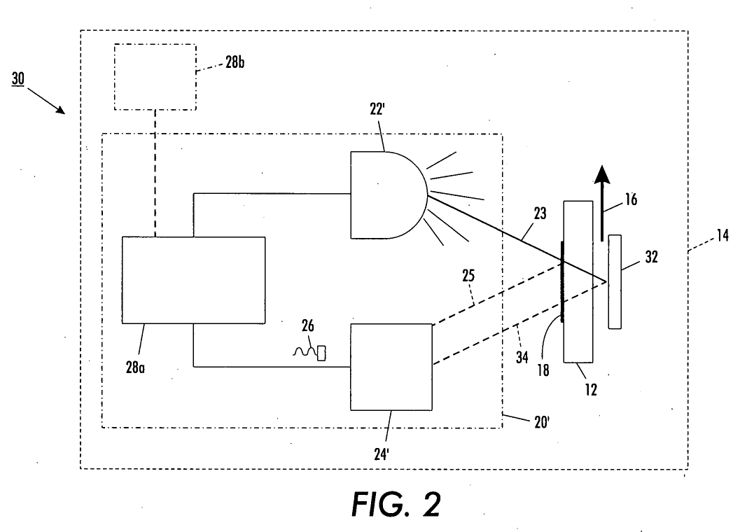

Referring now to FIG. 2, a block diagram of another embodiment of the system is shown generally at 30 in which components similar to the system 10 described above are shown with like reference numerals. The system 30 includes a sensor 20′ having an emitter 22′ and detector 24′. A reflector 32 is disposed opposite the paper path 16 from the sensor 20′ for reflecting radiation, shown as the dotted-dashed line 34, emitted from emitter 22′. The detector 24′ can also be configured to detect radiation reflected or emitted from the identifying markings 18 in a similar manner as described in FIG. 1.

In this example, the detector 24′ detects the reflected radiation 25 at full intensity until the printing media 14, such as for example a transparency, moves into the paper path 16. As the printing media 14 moves between the reflector 32 and the sensor 20′, the radiation emitted by emitter 22′ interacts with the identifying markings 18 twice, for example, it is attenuated twice, thereby increasing the efficiency of the sensor 20′. With this sensing configuration, the identifying markings 18 can be formed with material that absorbs less radiation than the configuration of FIG. 1 and while still being detectable by the sensor 20′. Such material can retain more of its transparent properties. The increased amount of attenuation at the predetermined frequencies of this example can also enable the controller 28 to use thresholds with larger ranges in determining that the markings indicate that the printing media 12 is appropriate, thereby simplifying the electronics.

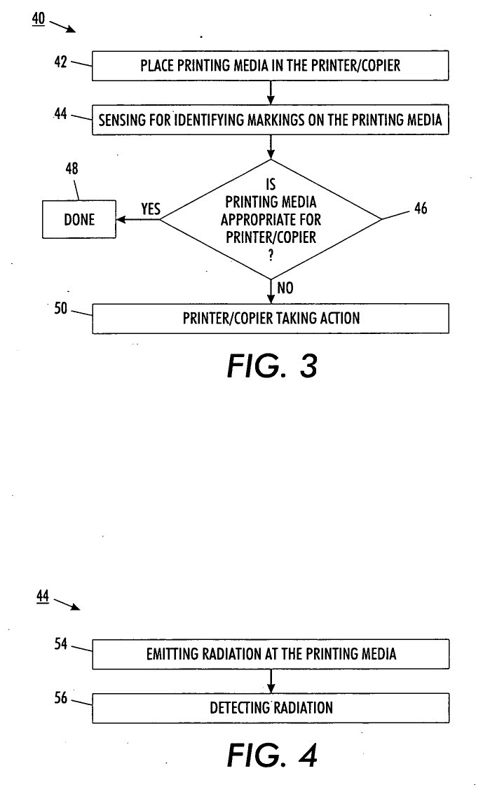

Referring now to FIG. 3, a method for obtaining information from a printer/copier printing media 12 and using the obtained information in determining if the printing media is appropriate for use in the printer/copier is shown generally at 40. The method 40 includes placing printing media 12 in the printer/copier at 42. The method 40 also includes sensing for identifying markings 18 on the printing media 12 at 44. The method 40 also includes determining if the printing media 12 is appropriate for the printer/copier at 46. The method 40 can also include the controller 28 taking action at 50 if the printing media 12 is not appropriate for the printer/copier 14. The action taken at 50 can include those actions described, including but is not limited to, notifying the operator of the printer/copier 12 with a warning message, among others, and/or preventing the use of the inappropriate printing media in the printer/copier.

Referring now to FIG. 4, the step of sensing for identifying markings 18 on the printing media 12 in step 44 of FIG. 2 can include emitting radiation at the printing media at 54. The sensing step 40 can also include detecting radiation at 56 with the detector 24. The radiation detected can be emitted by the emitter 22 and reflected from the identifying markings 18, or it can be emitted by the identifying markings, such as by florescence, as described herein. The detector 24 produces an output signal 26 having characteristics representative of the identifying markings 18.

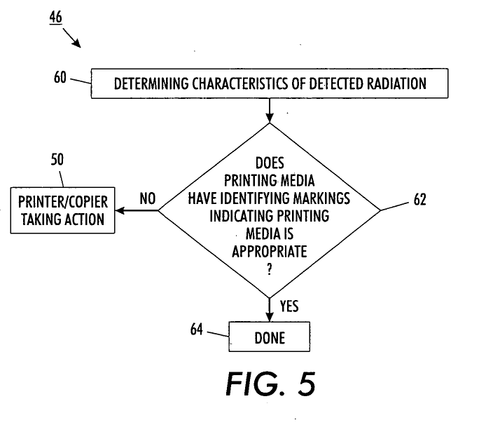

Referring now to FIG. 5, the step 46 of determining if the printing media 12 is appropriate for the printer/copier 14 can include determining the characteristics of the detected radiation at 60 using the output signals 26 produced by the detector 24. Examples of the characteristics of the detected radiation can include, but are not limited to, the intensity of the radiation detected, the wavelength of the radiation detected, and the decay rate of the intensity of the radiation detected.

The controller 28 receives the detector output signals 26 and determines if these signals indicate that printing media 12 has the identifying markings 18 indicating that the printing media is appropriate for the printer/copier at 62. If the controller 28 determines that the printing media does not have identifying markings indicating that the printing media is appropriate for the printer/copier at 62, the controller 28a or 28b can then take action at 50 accordingly, including but not limited to the action or actions described above. The controller 28 can determine that the printing media 12 does have identifying markings indicating that the printing media is appropriate for the printer/copier at 62 if the output signals 26 from the detector 24 have expected characteristics associated with printing media known to be appropriate, examples of which are described in further detail below.

In one example embodiment, the system 30 of FIG. 2 includes a sensor 20′ for sensing for identifying markings 18 on the printing media 12 which absorb near-IR radiation. The identifying markings 18 are a clear, near-IR absorbing coating applied to a transparent printing media 12. The coating is a polyester binder (Fine-Tone 382-ES from Reichhold Chemical) containing a near-IR dye (SDB6592 from H.W. Sands) that has a broad absorption in the near-IR wavelength at frequencies of about 800 nm to about 1100 nm. The dye material used for the identifying markings 18 was selected to absorb a minimum amount of radiation at visible light wavelengths and is therefore clear or nearly-clear to the unaided eye under white light. Clear/nearly-clear identifying markings 18 will not interfere with the image generated on the printing media 12.

The emitter 22′ emits near-IR radiation in range of about 800 nm to about 1100 nm. The emitter 22′ can be configured to emit radiation at a broader range of wavelengths. The detector 24′ detects near-IR radiation in the range of about 800 nm to about 1100 nm, though the detector can be selected/configured to detect wavelengths at a narrower or broader range of radiation wavelengths. Further, as stated above, materials absorbing radiation at other frequencies can also be used in conjunction with an emitter and detector configured or chosen to operate at these frequencies.

The printing media 12 is placed in the printer/copier at 42 and the printer/copier 14 senses for the identifying markings 18 on the printing media 12 at 44. In the sensing step 44, the controller 28 directs the emitter 22 to emit near-IR radiation at 54 at the printing media 12, such that if the printing media contains the identifying markings 18, the emitted radiation 23 is directed at the identifying markings and is reflected back to the detector 24 by the reflective patch 32. The identifying markings 18 absorb at least some of the near-IR radiation at the predetermined frequencies of about 800 nm to about 1100 nm.

The detector 24′ detects the reflected radiation 25 at 56 and generates an output signal 26, in this example an output voltage, which is representative of the intensity of the radiation detected. The output voltage signal 26 is provided to the controller 28. The controller 28 determines the characteristics of the detected radiation at 60 using the output voltage signal 26. In this example, the identifying makings 18 absorb at least some of the near-IR radiation and the reflected radiation 25 has less intensity than if the identifying markings were not present or if they absorbed radiation at other wavelengths. As a result, the detector 24′ generates an output voltage signal 26 that is lower in value than would be generated if the identifying markings were not present or if they absorbed radiation at other wavelengths. The controller 28, receiving a reduced detector output voltage signal 26, determines that the printing media 12 has identifying markings indicating that the printing media is appropriate for the printer/copier 14 at 66. If the output voltage signal 26 is not within the range expected by the controller 28, the controller determines that printing media 12 does not have identifying markings indicating that the printing media is appropriate for the printer/copier at 62 and takes action at step 50 as described above.

In another example, the printing media 12 includes radiation-emitting identifying markings 18 which emit radiation having predefined characteristics as described herein. Examples of suitable radiation-emitting materials used for the identifying markings 18 can include phosphorescent materials which phosphoresce, thereby emitting radiation, even after the emitter 22 stops emitting radiation. Examples of phosphorescent materials that can be used include, but are not limited to, 4-bromofluorescein a phosphorescent dye. The characteristics of the radiation 25 emitted by the radiation-emitting markings 18 can be adjusted to uniquely identify the printing media 12 by selecting the type of phosphor in the material having a predetermined phosphorescence, emitting radiation at a predetermined frequency and intensity, and by using a predetermined amount of the radiation material, such as phosphor, in the identifying markings material. Also, a predetermined type and intensity of the radiation produced by the detector can be used to provide predetermined emission characteristics for an expected identifying marking material.

Another example of a radiation-emitting material is Alexa Fluor 350 from Synthegen, LLC which has an absorption spectrum in the UV region without significant extension into the visible region, while having an emission spectrum in the blue light region. Other radiation-emitting materials can include luminescent materials or fluorescent materials.

In operation, the printing media 12 is placed in the printer/copier at 42. The printer/copier 14 includes an emitter 22 capable of emitting radiation at a predetermined frequency, or frequencies, which will cause the radiation-emitting material to emit radiation, such as for example, causing phosphorescent identifying markings 18 to phosphoresce. In the sensing step 44, the controller 28 directs the emitter 22 to emit radiation at the predetermined frequency at 54 which is directed toward the printing media 12 in the paper path 16 where the identifying markings 18 are expected to be. The method 40 also includes detecting emitted radiation 25 coming from the radiation-emitting material 18, such as for example phosphorescent material, at 56. The controller can direct the emitter 22 to be turned off after a predetermined time interval while detecting the radiation emitted from the identifying markings 18.

Ambient light can be reduced or eliminated, for example by using a housing to cover the paper path 16 near the sensor 20, to improve the signal to noise ratio of the detector output signal 26. If no emitted light 25 is detected at 56, the controller 20 can determine that no identifying markings 18 are present at 46 and thus the printing media 12 is not appropriate for the printer/copier 14. If emitted light 25 is detected by the detector 24, the detector produces a detector output signal 26, also referred to as the sensor output signal, representing the characteristics of the detected radiation and sends the signal to the controller 28.

The controller 28 determines the characteristics of the detected radiation 25 emitted by the radiation-emitting identifying marking material 18 from the output signal at 60. Examples of these characteristics can include, but are not limited to, the intensity, the wavelength and the decay time. The wavelength of the emitted radiation 25 can be determined by using a detector having the ability to detect predetermined wavelengths, among others. The intensity can be determined by producing a detector output 26, such as for example a voltage, representative thereof. The decay time can be determined by measuring the intensity of the emitted radiation 26 for a time period after the emitter 22 has been turned off by the controller 28. The controller 28 can use one or more of these characteristics to determine that the printing media 12 does or does not have identifying markings which indicate that the printing media is appropriate for use in the printer/copier 14.

Referring now to FIGS. 6-9, the printing media 12a-12 is shown having an image side 70 for receiving printing from the printer/copier 14 and a back side 72. The printing media 12 can be an opaque sheet, suitable for printing applications performed by a printer/copier 14 as described above, such as uncoated paper or synthetic materials such as waterproof papers, examples of which can include, opaque polyester films, such as Never Tear® paper sold by Xerox, opaque polyolefin films, such as Teslin® manufactured by PPG Industries, or polyethylene terephthalate (PET) films, among others.

The printing media 12a-12 can also be a transparency, including any clear film suitable for printing applications performed by a printer/copier 14. This may include materials such as PET, polyethylene naphthalate (PEN), and acetates, among others. Typically, films such as PET have on their surface a coating, also referred to as a “subbing” layer, that helps provide a suitable surface for the subsequent application of other coatings. The printing media can often include additional coatings, such as coatings 74 and 76 as seen in FIGS. 7 and 8, applied to the image side 70 and back side 72. Typically, the image side coating 74 contains a resin or a blend to receive the toner or ink from the printer/copier 14, filler particles to aid in the transport of the sheet 12 through the printer/copier, plus in the case of films intended for use in a laser printer or xerographic copier, an antistatic agent to control static electric charging. The back side coating 76 is often designed to provide reliable transport through the printer/copier 14. Thus, the backside coating 76 composition is established to provide control of properties such as coefficient of friction, although it may also contain antistatic agents to influence toner transfer to the sheet in the case of films for electrophotographic applications.

Printing media 12 such as aqueous ink jet papers, solid ink papers, etc., for use in printing systems 10 can also benefit from using the system and method described herein, since these media also have specific characteristics, such as absorbency, among others, which should be matched up with the printing systems to provide optimal printing results.

With reference to FIG. 6, the printing media 12 is shown having identifying markings 18a on the edge 73 of the printing media so as to not interfere with forming the image on the media. The identifying markings 18a can be applied along the edge 73 in any suitable manner described herein.

The printing media 12 can include identifying markings 18a′ using an ink that contains a suitable marking material applied to a removable tape strip 78 which is applied to the printing media 12. The removable tape 78 can include a pressure sensitive adhesive 79 allowing the tape to be applied during the manufacture of the printing media 12. The tape 78 with markings 18a′ can be applied along the sheet edge 73 outside of the image area. After printing, the tape 78 is removed from the printing media 12 to remove the evidence of a marking system. Using removable tape 78 having the identifying markings 18a′ in this manner can help curb the use of pirate copies of the printing media 12 which are inappropriate for use in the printer/copier 14.

The detectable material used for the identifying markings 18a′, such as a UV absorbing, or near-IR absorbing dye, a phosphorescent material, or a luminescent material, can be applied to the tape 78, such as to the back-side of a clear tape 78 so that it will be detectable when passing by the sensor 20. Examples can include, but are not limited to polyester tape. Alternatively, the markings material can be mixed into the pressure sensitive adhesive 79. The identifying marking tape 78 can be applied to the printing media 12, such as for example, a transparency and can be detected by the sensor 20 thereby providing the information to the controller 28 for determining appropriateness. The normally-reflective tape 78 will now absorb UV or IR, or near-IR radiation and appear “black” when passed in front of the sensor 20.

Regardless of which approach is taken to introduce the detectable material into the tape 78, having the identifying markings material 18 in the tape has advantages. The customer can remove the tape 78 after printing to remove the identifying markings from the printing media 12. This would eliminate any residues of the identifying markings 18, which might otherwise intrude into the end-user's field of view. Further, since there is no modification is made to the printing media coating 74, 76 itself, the identifying markings 18 cannot affect desirable qualities of the printing media, such as clarity, haze, or toner transfer properties. Thus, the technical issues associated with developing a high-quality printing media 12 are separated from those associated with developing the detection system providing the information of determining appropriateness.

With reference to FIG. 7, a printing media 12 is shown having an image side 70 for receiving printing from the printer/copier 14 and a back side 72. The printing media 12 includes an optional image side coating 74 formed on the image side 70. The printing media 12 can also include an optional back side coating 76 formed on the back side 72. Printing can be done on the back side 72. The back side coating 76 can be the same as the image side coating 74, or it can be different. The printing media 12 also includes identifying markings 18b. The identifying markings 18b can be formed on one of the image side 70 or the back side 72, or on both sides (as shown).

With reference to FIG. 8, a printing media 12 is shown having an image side 70 and a back side 72. The printing media 12 includes an image side coating 74 formed on the image side 70. The printing media 12 can also include an optional back side coating 76 formed on the back side 72. The back side coating 76 can be the same as the image side coating 74, or it can be different. The printing media 12 also includes identifying markings 18c. The identifying markings 18c can be formed on one of the image side 70 or the back side 72, or on both sides (as shown). The identifying markings 18c are shown applied to the printing media 12 beneath the image side coating 74 and beneath the back side coating 76. The identifying markings 18c are shown applied across the entire surface of the image side 70 and back side 72, although alternatively they can be applied along one or more edges.

With reference to FIG. 9, a printing media 12 is shown having an image side 70 and a back side 72. The printing media 12 includes identifying markings 18d formed on one of the image side 70, or the back side 72, or on both sides (as shown). The identifying markings 18d are combined or blended with a coating, such as the coatings 74, 76 described above, and can cover the entire surface of the image side 70 and back side 72. Although alternatively, the identifying markings 18d can be combined with the coating only along one or more edges 73. The coatings 74, 76 and identifying markings 18d can be different on each side to allow the printer/copier 14 to distinguish between sides 70, 72. Alternative constructions of the printing media sheet 12 could include the use of a separate coating that contains the identifying markings 18d, which is then applied either over or under the usual image side coating 74, or back side coating 76. Such systems could work if the image-side coating 74 or back-side coating 76 are transparent to the wavelength of light used in the sensor 20.

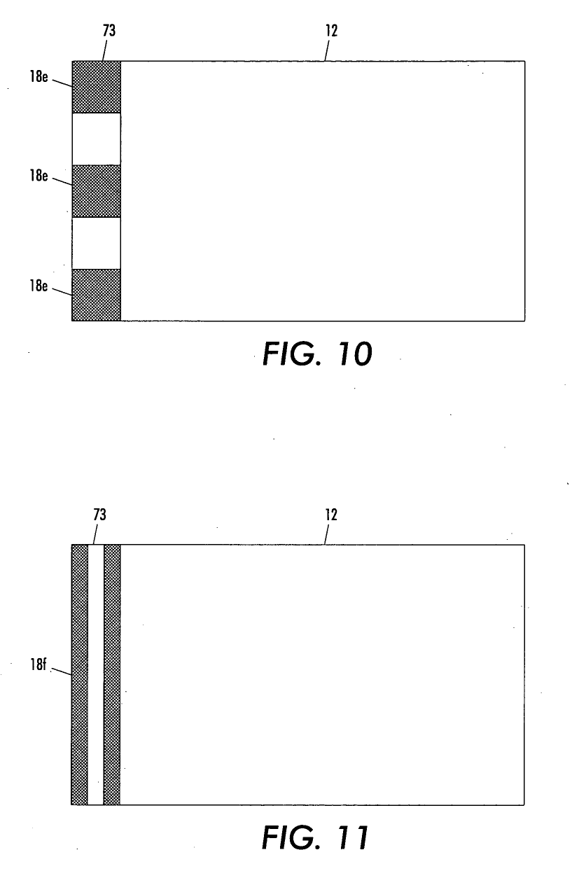

Referring now to FIGS. 10 and 11, top views of printing media 12 are shown having the identifying markings 18e and 18f respectively applied to the edge 73 thereof. The identifying markings 18e and 18f can be applied to the printing media 12 in a pattern. The pattern can be formed to provide a distinctive result in the output signal 26 when detected by the sensor 20 as the printing media moves along the path 16 to more uniquely identify the printing media. The changes to the output signal 26 as a result of the marking material pattern can therefore also be used to determine if the printing media is appropriate. For example, the markings 18e are applied adjacent to areas along the edge 73 having no markings which creates an alternating output signal 26 as the printing media 12 moves along path 16. In this manner, a larger number of unique output signals 26 can be generated with the same marking material and sensor, thereby uniquely identifying a larger number of different printing media 12, which in turn can be used in determining appropriateness as described above.

The embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method for a printer/copier obtaining information from printer/copier printing media comprising:
placing the printing media in the printer/copier;
the printer/copier sensing for identifying markings on the printing media identifying the printing media as the appropriate printing media for the printer/copier; and
the printer/copier determining if the printing media is the appropriate printing media for use in the printer/copier.

2. The method defined in claim 1 wherein the sensing step comprises:
emitting radiation at the printing media; and
detecting radiation.

3. The method defined in claim 2 wherein the determining step comprises:
determining the characteristics of the detected radiation detected in the detecting step; and
determining if the characteristics of the detected radiation indicate the printing media has identifying markings identifying the printing media as the appropriate printing media for the printer/copier.

4. The method defined in claim 3 wherein the printing media has ultraviolet light absorbing identifying markings and the detecting step comprises detecting light reflected from the identifying markings.

5. The method defined in claim 3 wherein the printing media has ultraviolet light florescent identifying markings and the detecting step comprises detecting light emitted from the identifying markings.

6. The method defined in claim 3 wherein the printing media has infrared light absorbing identifying markings and the detecting step comprises detecting light reflected from the identifying markings.

7. The method defined in claim 3 wherein the printing media has infrared light florescent identifying markings and the detecting step comprises detecting light emitted from the identifying markings.

8. The method defined in claim 3 wherein the printing media has radiation-emitting identifying markings and the detecting step comprises detecting radiation emitted from the identifying markings.

9. The method defined in claim 1 wherein the printing media has identifying markings that are not visible to the unaided human eye under white light.

10. The method defined in claim 1 further comprising the printer/copier taking action if the printing media is not the appropriate printing media for the printer/copier.

11. The method defined in claim 10 wherein the taking action step comprises notifying the user that the printing media is not the appropriate printing media for the printer/copier.

12. The method defined in claim 10 wherein the taking action step comprises preventing the use of the printing media in the printer/copier.

13. A printer/copier system for printing on printing media comprising:
a sensor for sensing for identifying markings on the printing media identifying the printing media as the appropriate printing media for the printer/copier and providing a sensor output signal; and
a controller connected to the sensor for receiving the sensor output signal for determining if the printing media is the appropriate printing media for the printer/copier.

14. The printer/copier system defined in claim, 13 wherein the sensor comprises:
an emitter for emitting radiation at the printing media; and
a detector for detecting radiation.

15. The printer/copier system defined in claim 14 wherein the controller determines the characteristics of the detected radiation from the sensor output signal and determines if the characteristics indicate the printing media has identifying markings identifying the printing media as the appropriate printing media for the printer/copier.

16. The printer/copier system defined in claim 13 further comprising a controller for taking action if the printing media is not the appropriate printing media for the printer/copier.

17. The printer/copier system defined in claim 16 wherein the controller for taking action notifies the user that the printing media is not the appropriate printing media for the printer/copier.

18. The printer/copier system defined in claim 16 wherein the controller for taking action prevents use of the printing media in the printer/copier.

19. The printer/copier system defined in claim 13 wherein the sensor senses for identifying markings not visible to the unaided human eye under white light.

20. The printer/copier system defined in claim 13 further comprising printing media having identifying markings identifying the printing media as the appropriate printing media for the printer/copier.

21. Sheet printing media for use in a printer/copier comprising:
identifying markings capable of being sensed by a radiation sensing sensor for indicating that the printing media is the appropriate printing media for the printer/copier.

22. The printing media defined in claim 21 wherein the identifying markings are not visible to the unaided human eye under white light.

23. The printing media defined in claim 21 wherein the identifying markings comprise an ultraviolet light absorbing material.

24. The printing media defined in claim 21 wherein the identifying markings comprise an ultraviolet light florescent material.

25. The printing media defined in claim 21 wherein the identifying markings comprise an infrared light absorbing material.

26. The printing media defined in claim 21 wherein the identifying markings comprise an infrared light florescent material.

27. The printing media defined in claim 21 wherein the identifying markings comprise a radiation-emitting material.
